(19) United States
(12) Patent Application Publication
(10) Pub. No.: US 2015/0154980 A1
(43) Pub. Date: Jun. 4, 2015

(54) CEPSTRAL SEPARATION DIFFERENCE

(71) Applicant: JEMARDATOR AB, Orsa (SE)

(72) Inventors: Taha Khan, Borlange (SE); Jerker Westin, Orsa (SE); Mark Daugherty, Gagnef (SE)

(73) Assignee: JEMARDATOR AB, Orsa (SE)

(21) Appl. No.: 14/407,848

(22) PCT Filed: Jun. 5, 2013
(86) PCT No.: PCT/SE2013/050648

§ 371 Date: Dec. 12, 2014

Related U.S. Application Data
(60) Provisional application No. 61/660,443, filed on Jun. 15, 2012.

(51) Int. Cl. G10L 21/06; G10L 19/02

(52) U.S. Cl. CPC G10L 21/06; G10L 19/02

(57) ABSTRACT

A method for characterization of a human speech comprises performing (220) of a discrete transform on a speech sample of the human speech. A speech logarithmic power spectrum is created (222) by taking a logarithmic of the speech frequency spectrum. An inverse discrete transform is performed (224) on the speech logarithmic power spectrum into the quefrency domain. Lifterings (226, 228) of the speech cepstrum is performed, giving a high and low end speech cepstrum, respectively. The discrete transform is performed (230) on the high end speech cepstrum, creating a source excitation log-power spectrum. The discrete transform is performed (232) on the low end speech cepstrum, creating a vocal tract filter log-power spectrum. A cepstral separation difference is calculated (234) as a difference between the source excitation log-power spectrum and the vocal tract filter log-power spectrum. The human speech is characterized (238) based on the cepstral separation difference.

### TECHNICAL FIELD

The present invention relates in general to methods and devices for speech characterization and in particular to such methods and devices based on analysis of recorded speech samples.

### BACKGROUND

Characterization of speech is used in many different applications today, including but not limited to voice recognition, lie detection, voice training assistance and speech impairment assessment. A common feature for all such applications is to extract information of different parts of the speech creation process in order to be able to identify characteristic or non-normal detailed features.

For instance, in the field of Parkinson's disease, assessment of speech impairment may assist in improving the quality of life of patients with diagnosed Parkinson's disease. Parkinson's disease (PD) is characterized by the loss of dopaminergic neurons in brain. This loss results in dysfunction of brain circuitry that mediates motor functions. As a result of the cell death, there can be a number of motor symptoms such as rigidity, akinesia, bradykinesia, rest tremor and postural abnormalities. Physical symptoms that can occur in the limbs can also occur in the speech system. This may lead to a speech disorder due to a change in muscle control, e.g. muscular rigidity. Vocal impairment is an early indicator of PD and 90% of People with Parkinson's (PWP) suffer from speech and vocal tract (Larynx) anomalies. The anomalies in the speech get worse with the disease progression.

Parkinson's disease can affect respiration, phonation, resonation and articulation in speech. Respiration problems are the cause of reduced voice loudness or power in PWP [2]. The reason is that control of inhalation and exhalation enables a person to maintain adequate loudness of speech through a conversation. A PWP may speak on the “bottom” of his or her breath i.e. inhale, exhale, then speak; rather than on the “top” i.e. inhale, speak, exhale remaining air. The voice of PWP is an average of 2-4 dB softer than the normal voice.

Breathing effects in pathological speech are produced due to effortful glottal closures at the Trachea Bronchi which block the air to flow through the vocal tract [3]. When the glottal source reopens, the turbulent air leaks in short bursts through the vocal folds. The sound bursts created due to muscular constrictions are in a form of a noise-source. The dissymmetry of the glottal flow waveform is an important voice quality determinant as it increases the magnitude of source-excitation energy in the impaired speech waveform. The fricatives involve a greater degree of obstruction in speech, which gives rise to increased dissymmetry in glottal flow waveform due to sudden energy bursts.

Vocal fold vibration during phonation creates pitch of the voice. The vocal folds vibrate quickly during high-pitched sounds and vibrate slowly during low-pitched sounds. A PWP notices changes in pitch of their voice. Monotone or lack of vocal inflection or melody in voice is also a common complaint. To quantify the disease severity, assessments are made by clinicians using a metric called Unified Parkinson's Disease Rating Scale (UPDRS). UPDRS is categorized in three sections i.e. ‘Mentation, Behavior and Mood’, ‘Activities of Daily Living’ and ‘Motor Examination’. The motor examination encompasses speech, rest tremor, muscular rigidity postural abnormalities and finger tapping assessments. Overall ratings based on motor examination of UPDRS are ranged from 0 to 108 where 0 represents a normal state and 108 refer to total motor impairment. The ratings for Motor Examination of Speech (MES) are ranged from 0 to 4 (where 0 denotes normal, 1 denotes mild, 2 denotes moderate, 3 denotes severe and 4 denotes unintelligible). Traditionally, the MES is performed using sustained and continuous phonation examinations in which the clinician assesses the recorded speech based on the lurking articulation and vocal breathiness of the subject. In other speech tests, patients are asked to read aloud standard phrases and sentences which are recorded and analyzed using speech processing methods to characterize between the PD speech symptoms. Previous work on speech assessments were limited to classify between PWP and normal controls. For an accurate tele-monitoring of PD speech symptoms, it is an important matter of investigation to statistically map the speech features to the clinician ratings of a subject based on the MES. Prior art tele-monitoring speech assessments have not been able to reach acceptable accuracy for reliably supporting MES.

The Lee Silverman voice treatment (LSVT) therapy system was introduced for speech and movement disorders in a patent by Ramig et al. [4]. The LSVT consisted of a variety of voice exercises including sustained vowel phonation, pitch exercises, reading and conversational activities. This speech therapy was used to improve speech impairment in PD patients as their speech deteriorates with the disease progression. An extension of this work was made by embedding LSVT therapy system in a mobile device known as LSVT Companion (LSVTC). LSVTC was programmed to collect data on sound pressure level (SPL), fundamental frequency (FO) and duration of phonation. It was used to provide feedback to individuals on their performance during LSVT therapy. LSVTC was employed with simple bar graphs to indicate SPL, pitch, and time. Using bar graphs, patients could maintain the SPL during their voice therapy.

N. Solomon investigated 14 male PWP and 14 healthy controls for PD classification based on breathing anomalies in speech [5]. He utilized SPL and phonation range to classify between them. Amplitude calibration (varying distance between mouth and mouth-piece) was found to be the drawback in estimating SPL. Also, some people (e.g. singers or public debaters) may speak with a louder voice than others. SPL therefore cannot be utilized for symptom characterization in PD speech.

Articulatory rate and pause time were other features to discriminate PD [6]. Tsanas et al. [7] introduced features called vocal fold excitation ratio, glottis quotient and glottal to noise excitation to represent breathing problems in PWP. The representation of first and second harmonics (H1 and H2) of speech signal is based upon the source-filter theory of speech signal where H1 and H2 represent the source characteristics of sound pressure. The amplitude of first harmonic H1 during an intended voice production of fricatives in dysarthric speech was investigated previously [8]. A laryngeal coordinative difficulty was indicated when H1 invaded the fricative location in speech which was prominent in L-DDK tests. The amplitude difference between the first two harmonics (H1-H2) of speech signal can be used to estimate the breathing differences due to glottal constrictions in pathological voice. The breathy voice has stronger H1 which resulted in higher values of H1-H2 in pathological voice [9].

The H1H2 analysis of excitation source bypasses the practical limitations in inverse filtering of vocal tract components [10]. The limitations consisted of the difficulty in amplitude calibration due to the distance between microphone and mouth. Moreover, the inverse filtering method is susceptible to low-frequency noise. A low-frequency error can be introduced due to air displacement by the articulator movement especially in the case when voice becomes breathy due to a poor glottal closure which is a typical symptom in dysarthria. Though, the elimination of these problems makes H1H2 a very suitable feature to represent breathing anomalies, the information related to the air-pressure in vocal tract may be utilized along with the air-pressure in source-excitation for a symptom characterization of PD. However, also such an approach is insufficient in many cases.

Previous studies on cepstrum analysis in connection with a source-filter model of speech revealed that the direction of cepstrum vector is directly dependent on the vocal tract length disregard of the age and the gender differences. The adaptation of Mel-Frequency cepstral coefficients for the diagnosis of PD has been previously investigated for classification between healthy and pathological voice. However, experiments on cepstral coefficients using Linear Vector Quantization algorithm only yielded a classification accuracy of 90% and 95% for normal controls and PWP respectively.

A difficulty in the clinical assessment of running speech is to track underlying deficits in individual speech components which as a whole disturb the speech intelligibility.

### SUMMARY

An object of the present disclosure is to improve characterization of a human speech. These objects are achieved by methods and devices according to the enclosed independent patent claims. Preferred embodiments are defined in the dependent claims. In general, in a first aspect, a method for characterization of a human speech comprises performing of a discrete transform on a speech sample of the human speech in the time domain into the frequency domain. A speech frequency spectrum is thereby created, defined by a set of frequency coefficients. A speech logarithmic power spectrum in the log-power domain is created by taking a logarithmic of the speech frequency spectrum. An inverse discrete transform is performed on the speech logarithmic power spectrum into the quefrency domain. The inverse discrete transform is the inverse to the earlier used discrete transform. A speech cepstrum is thereby created, defined by a set of cepstral coefficients. A high-time-liftering of the speech cepstrum is performed, giving a high end speech cepstrum, and a low-time-liftering of the speech cepstrum is performed, giving a low end speech cepstrum. The discrete transform is performed on the high end speech cepstrum into the log-power domain, thereby creating a source excitation log-power spectrum. Likewise, the discrete transform is performed on the low end speech cepstrum into the log-power domain, thereby creating a vocal tract filter log-power spectrum. A cepstral separation difference is calculated as a difference between the source excitation log-power spectrum and the vocal tract filter log-power spectrum. The human speech is characterized based on the cepstral separation difference.

In a second aspect, a device for characterization of a human speech comprises a central processor unit. The central processor unit has an input for a speech sample of the human speech in the time domain. The processor is configured for performing a discrete transform on the speech sample of the human speech in the time domain into the frequency domain. A speech frequency spectrum is thereby created, defined by a set of frequency coefficients. The processor is further configured for creating a speech logarithmic power spectrum in the log-power domain by taking a logarithmic of the speech frequency spectrum. The processor is further configured for performing an inverse discrete transform on the speech logarithmic power spectrum into the quefrency domain. This inverse discrete transform is the inverse to the discrete transform used earlier. This creates a speech cepstrum, defined by a set of cepstral coefficients. The processor is further configured for high-time-liftering of the speech cepstrum, thereby giving a high end speech cepstrum. The processor is further configured for low-time-liftering of the speech cepstrum, giving a low end speech cepstrum. The processor is further configured for performing the discrete transform on the high end speech cepstrum into the log-power domain, thereby creating a source excitation log-power spectrum. The processor is further configured for performing the discrete transform on the low end speech cepstrum into the log-power domain, thereby creating a vocal tract filter log-power spectrum. The processor is further configured for calculating a cepstral separation difference as a difference between the source excitation log-power spectrum and the vocal tract filter log-power spectrum. The processor is further configured for characterizing the human speech based on the cepstral separation difference. The processor has an output for this characterization of the human speech.

An advantage of the present invention is that the cepstral separation difference provides a source of information about the human speech that easily and accurately can be utilized for characterization of different aspects of a human speech. Further advantages of preferred embodiments are discussed in connection with the detailed description below.

### BRIEF DESCRIPTION OF THE DRAWINGS

The invention, together with further objects and advantages thereof, may best be understood by making reference to the following description taken together with the accompanying drawings, in which:

FIG. 1A is a schematic description of the generation of speech;

FIG. 1B is a schematic illustration of the Source-Filter Model of Speech;

FIG. 2 is a flow diagram of steps of an embodiment of a method for characterization of a human speech;

FIG. 3 is a block diagram of an embodiment for calculation of Cepstral Separation Difference;

FIG. 4A-D are diagrams of test samples of normal, mild, moderate and severely impaired speech samples;

FIG. 5 is a schematic illustration of the use of a platform to record speech for an impairment analysis based on mobile devices with central processing units; and

FIG. 6 is a block diagram of parts of an embodiment of a device for characterization of a human speech.

### DETAILED DESCRIPTION

Throughout the drawings, the same reference numbers are used for similar or corresponding elements.

As a basis for the description below, a short summary of the human anatomy of speech production is first given. Periodic vibration of the vocal folds is termed as voice phonation. The phonation rate is affected by the setting of laryngeal muscles. These muscular settings are responsible for determining the modes of vocal fold vibrations to produce voiced phonations as well as breathy or creaky voice representing certain pathological vibrations. The glottis is the opening in the larynx which is connected to the vocal folds (supra-glottal) at the anterior and with the lungs and trachea bronchi (sub-glottal) at the posterior. The lungs act as the basic source of speech production that produces air pressure which passes through the glottis and is modulated by the vocal fold vibration to form a speech signal. A speech signal may be periodic (voiced), or aperiodic (whispers). Periodic and aperiodic sounds may be generated simultaneously to produce mixed voice (e.g. breathy voice) typical of pathological sounds.

The breathing effect in an impaired voice is produced due to effortful glottal closures at Trachea Bronchi which blocks the air pressure to flow through the vocal tract resulting in the lower ratio of air pressure. The turbulent air at Trachea Bronchi leaks in short rushes producing random peaks in the voice spectrum.

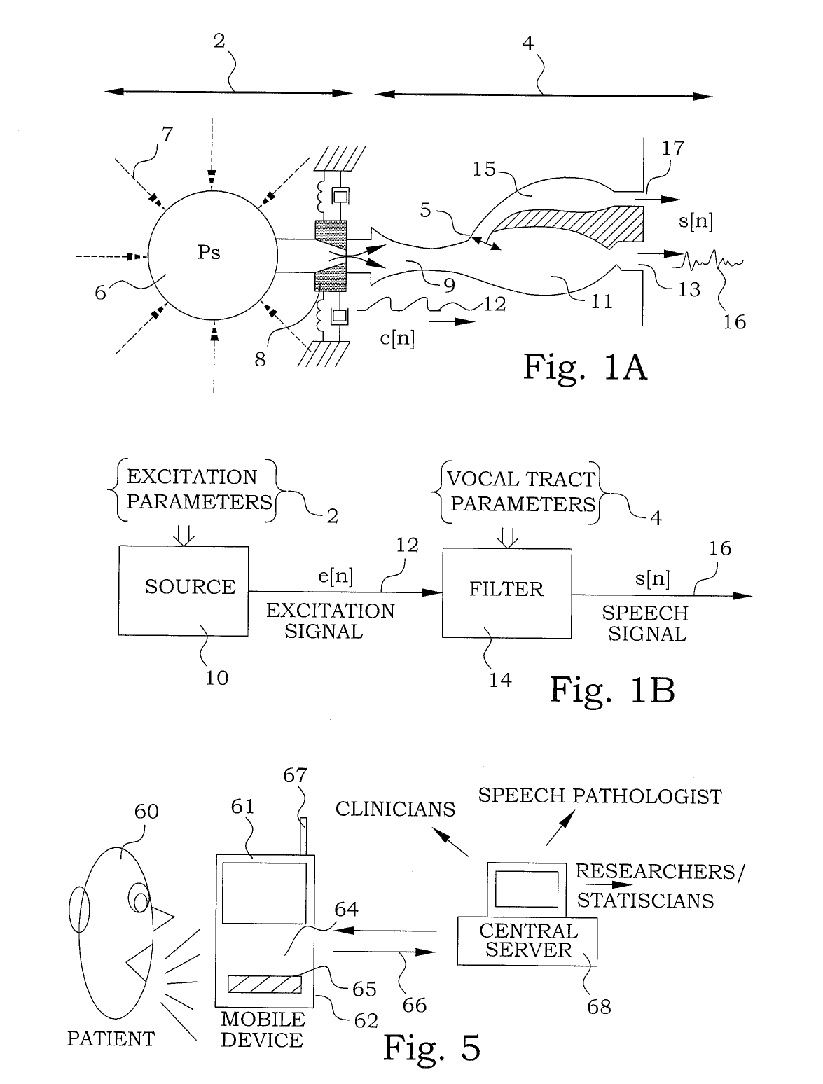

A Source-Filter Model of Speech is often used as a model of speech production [11]. The model is well-suited for symptom analysis in speech since it provides a framework of physiological interaction between the body organs to produce voice. According to the source-filter model, speech production is a two-stage process involving generation of a sound-source excitation signal having independent spectral properties which is then filtered by the independent resonant properties of vocal tract signal. FIG. 1A schematically describes the generation of speech. An excitation signal e[n] 12 is generated by the air pressure Ps expelled from the lungs 6. The air flow passes between the vocal folds at Trachea Bronchi 8. The muscle force 7, the lungs 6 and the trachea bronchi 8 determines the excitation parameters 2. The vocal tract 11, together with the vocal cords 9, nasal tract 15 and the velum 5 creates a resonance space characterized by vocal tract parameters 4. The resonance h[n] filters the air to produce the speech signal s[n] 16, leaving the mouth 13 and nostril 17. In case of a glottal source (sub-glottal region), the filter is the entire vocal tract (supra-glottal region).

The Source-Filter Model of Speech is schematically illustrated in FIG. 1B. The excitation parameters 2 govern how the source 10 produces the excitation signal e[n] 12. The vocal tract parameters 4 set the filter 14 to give rise to the final speech signal s[n] 16.

As mentioned before, cepstrum analysis in connection with a source-filter model of speech revealed that the direction of cepstrum vector is directly dependent on the vocal tract length disregard of the age and the gender differences. A Mel-frequency cepstrum (MFC) is a representation of the short-term power spectrum of a sound. The Mel-frequency cepstral coefficients (MFCC) collectively make up a MFC. The main difference between cepstrum and MFC is that, a Mel-filter bank divides the frequency bands in MFC into equal spaces. The filter banks in MFC consist of triangular filters. These filters compute the spectrum around each centre frequency with increasing bandwidths. This division of frequency bands provides a closer approximation of the human auditory system response compared to that of a linearly-spaced frequency band in the normal cepstrum. The MFCCs are therefore generally used in audio compression [12] or in speech recognition tasks [13].

In the present disclosure, an alternative approach is used on the cepstrum. By extracting the low-time parts and the high-time parts of the cepstrum separately and then transferring them back into a log-power domain, other aspects of the cepstrum can be addressed.

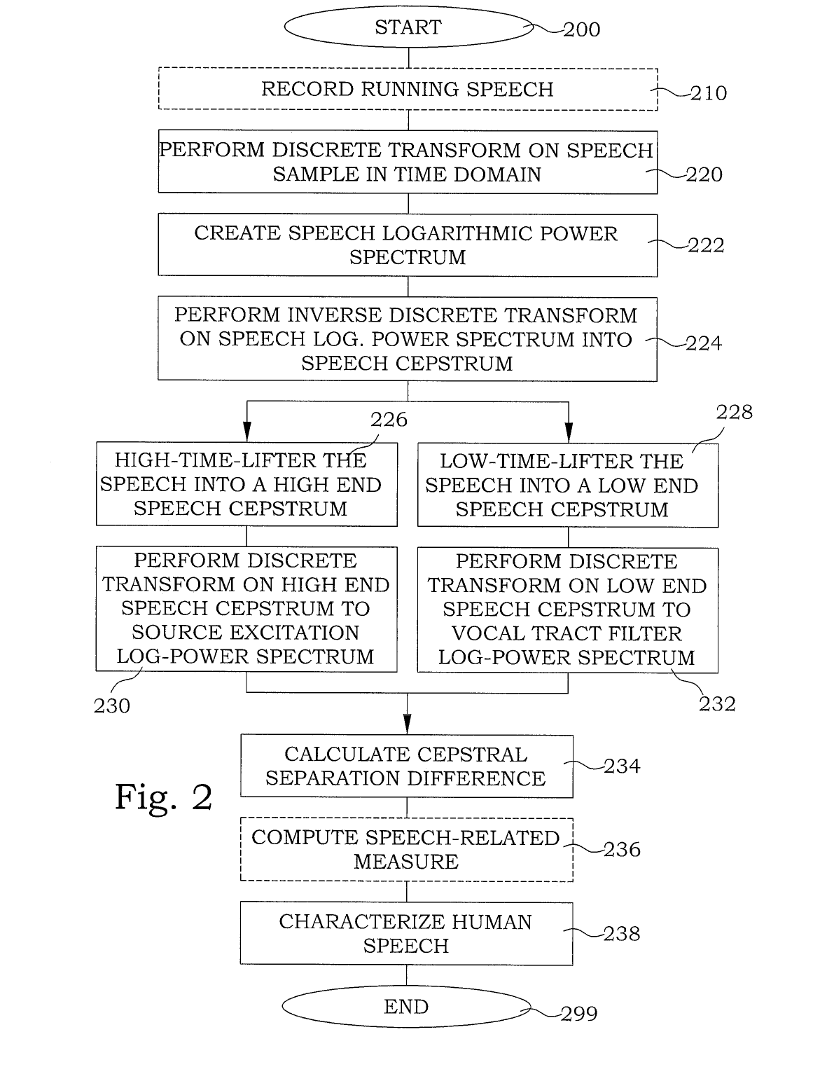

In FIG. 2, a flow diagram of steps of an embodiment of a method for characterization of a human speech is illustrated. The process starts in step 200. In step 220, a discrete transform is performed on a speech sample of the human speech in the time domain into the frequency domain. This transform thus creates a speech frequency spectrum defined by a set of frequency coefficients. In a preferred embodiment, the discrete transform is selected as one of a discrete Fourier transform, a discrete cosine transform and a discrete Z-transform. In the present embodiment, in step 222, a speech logarithmic power spectrum in the log-power domain is created by taking a logarithmic of the speech frequency spectrum. An inverse discrete transform is in step 224 performed on the speech logarithmic power spectrum into the quefrency domain. The inverse discrete transform is the inverse to the earlier used discrete transform. This inverse discrete transform creates a speech cepstrum defined by a set of cepstral coefficients. In step 226, the speech cepstrum is high-time-liftered, which gives a high end speech cepstrum. In other words, a selection of the part of the speech cepstrum at the highest times is made. A high-time liftering of a cepstrum in a quefrency domain is in some aspects analogue to a high-pass filtering of a spectrum in a frequency domain. Analogously, in step 228, the speech cepstrum is low-time-liftered, which gives a low end speech cepstrum. In other words, a selection of the part of the speech cepstrum at the lowest times is made. A low-time liftering of a cepstrum in a quefrency domain is in some aspects analogue to a low-pass filtering of a spectrum in a frequency domain.

In the cepstrum domain, the lower end of the cepstrum corresponds to the vocal tract filter of the Source-Filter Model of Speech, whereas the higher end corresponds to the source excitation component. One may therefore alternatively denote the low end speech cepstrum as a vocal tract filter cepstrum and the high end speech cepstrum as a source excitation cepstrum.

In step 230, the discrete transform is performed on the high end speech cepstrum into the log-power domain. This creates a source excitation log-power spectrum. Similarly, in step 232, the discrete transform is performed on the low end speech cepstrum into the log-power domain. This instead creates a vocal tract filter log-power spectrum. In step 234, a cepstral separation difference (CSD) is calculated as a difference between the source excitation log-power spectrum and the vocal tract filter log-power spectrum. The CSD is thus a spectrum in the log-power domain, where the contribution from the source excitation in some sense is compared in relation to the vocal tract filter contribution. In step 238, the human speech is characterized based on this cepstral separation difference. The process ends in step 299.

There are numerous possibilities to extract information about the human speech from the cepstral separation difference. Some of the possibilities will be further discussed below. In a preferred embodiment, comprising the step 236 of FIG. 2, the further step of computing at least one speech-related measure from said cepstral separation difference is included. The step 238 of characterizing the human speech is then based on this at least one speech-related measure. This is one possible way of reducing the high amount of information of the CSD into a limited treatable amount of data. However, in a basic version, the characterizing of the human speech can be made directly from the CSD as such.

The present method may be performed on stored speech samples of the human speech. Such a speech sample can be achieved by any procedures. However, in a typical particular embodiment, the method comprises the further step 210 of recording running speech as the speech sample of the human speech in the time domain. This is indicated in FIG. 1.

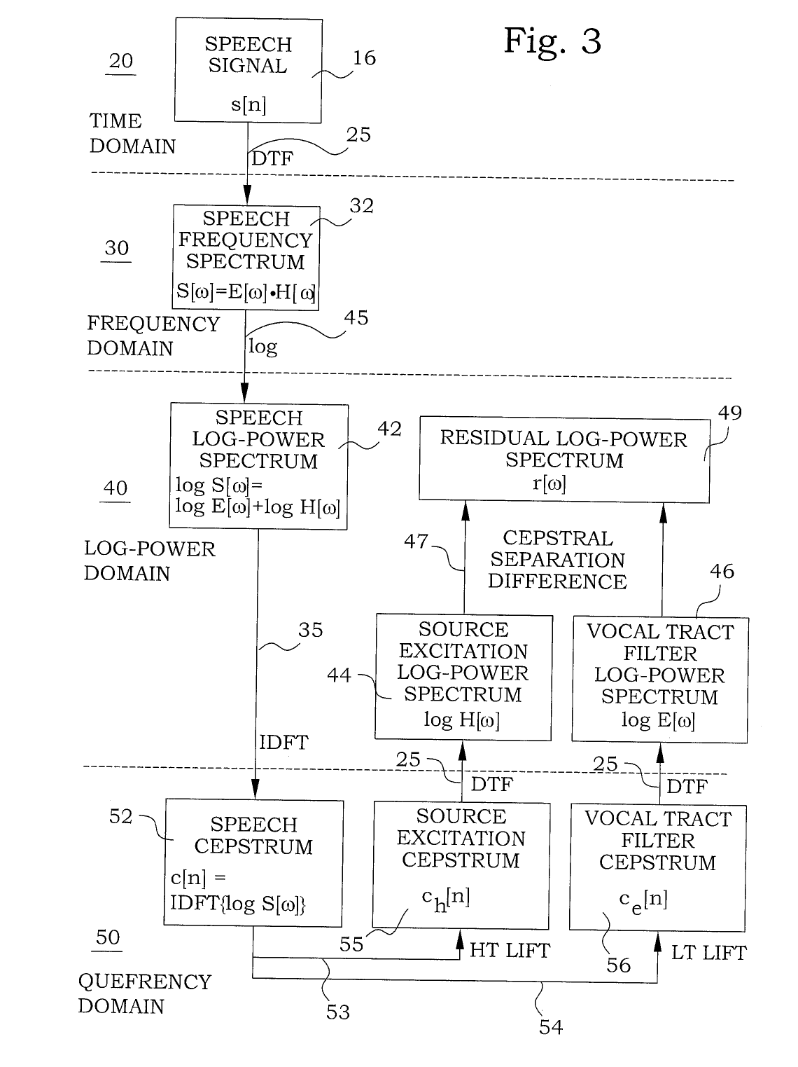

The process can also be described in a more formal mathematical way, with reference to an embodiment illustrated by FIG. 3. A speech signal s[n] 16 from the human being is provided in the time domain 20. After discrete Fourier Transform (DFT) 25, in the frequency domain 30, the speech frequency spectrum S[ω] 32 consisting of DFT coefficients ω can be considered as multiplication between source-excitation frequency E[ω] and vocal-tract filter frequency H[ω], see e.g. [14], as represented in eq. (1).

DFT{s[n]}=S[ω]=E[ω]·H[ω] (1)

By taking the logarithm 45 of the speech frequency spectrum S[ω] 32, the multiplication in the frequency domain 30 is transferred into a linear combination of the speech log-power spectrum 42 in the log-power domain 40. The linear combination of magnitude spectrums of E[ω] and H[ω] can thus represent the speech in logarithmic spectrums in the log-power domain 40:

log|S[ω]|=log|E[ω]|+log|H[ω]| (2)

The log-spectrum of a speech signal 42 can be separated by taking the inverse discrete Fourier transformation (IDFT) 35 of linearly combined log-spectrums of excitation frequency E[ω] and filter frequency H[ω]:

c[n]=IDFT(log|S[ω]|)=IDFT(log|E[ω]|)+IDFT(log|H[ω]|) (3)

The IDFT of log spectra transforms the speech frequency spectrum 32 via the speech log-power spectrum 42 into a speech cepstrum c[n] 52 in the quefrency domain 50, where n is the number of cepstral coefficients.

As mentioned earlier, in the cepstrum domain or quefrency domain, the lower end of the cepstrum corresponds to filter component whereas the higher end corresponds to the excitation component. The filter component can in one embodiment be estimated from the speech cepstrum c[n] 52 using a low-quefrency lifter Lₕ[n] 54, given as:

$${L}_{h} [ n ] = \begin{matrix}1 , & 0 < n < {L}_{c} \\ 0 , & {L}_{c} < n < N ,\end{matrix} \qquad ( 4 )$$

where, L_{c} is the cutoff length of lifter Lₕ[n] and N is the cepstrum length. The filter cepstrum cₕ[n] 56 or more precisely the vocal tract filter cepstrum is computed by multiplying cepstrum c[n] to the low-quefrency lifter Lₕ[n]:

cₕ[n]=Lₕ[n]*c[n] (5)

The excitation component can be estimated from the speech cepstrum c[n] 52 using a high-quefrency lifter Lₑ[n] 53, given as:

$${L}_{e} [ n ] = \begin{matrix}1 , & {L}_{c} < n < N \\ 0 , & else .\end{matrix} \qquad ( 6 )$$

The source excitation cepstrum cₑ[n] 55 is computed by multiplying cepstrum c[n] to the high-quefrency lifter Lₑ[n]:

cₑ[n]=Lₑ[n]*c[n] (7)

In alternative embodiments, other lifter definitions can be used. The cutoff length can e.g. be adapted to the type of voice signal that is analyzed. In the examples below, it is set to 20 ms, but this parameter can be varied within large ranges. The transition between the low-quefrency lifter and the high-quefrency lifter can also be designed in a different way. The high-quefrency end of the low-quefrency lifter may e.g. have successively decreasing response amplitude, either linear or curved, and the high-quefrency lifter is then typically provided with a complementary low-quefrency response function end. Also the total length of the lifters may be defined in a different way. One possibility is e.g. to restrict the upper end of the quefrency range, for which the analysis is made. In other words, the N value can be set differently and in particular embodiments also being made dependent on a speech type to be analyzed.

The log-magnitude frequency response 44, 46 (in decibels) of excitation and filter cepstrums 55, 56, respectively, can be recovered by applying DFT 25 separately on cₑ[n] (i.e. essentially IDFT (log|E[ω]|)) and cₕ[n] (i.e. essentially IDFT (log|H[ω]|), respectively). The procedure results in the separation of log-magnitude spectrum of speech frequency between excitation and filter log-magnitude spectrums as:

log|E[ω]|=DFT{cₑ[n]}=DFT{IDFT{log|E[ω]|}} (8)

log|H[ω]|=DFT{cₕ[n]}=DFT{IDFT{log|H[ω]|}} (9)

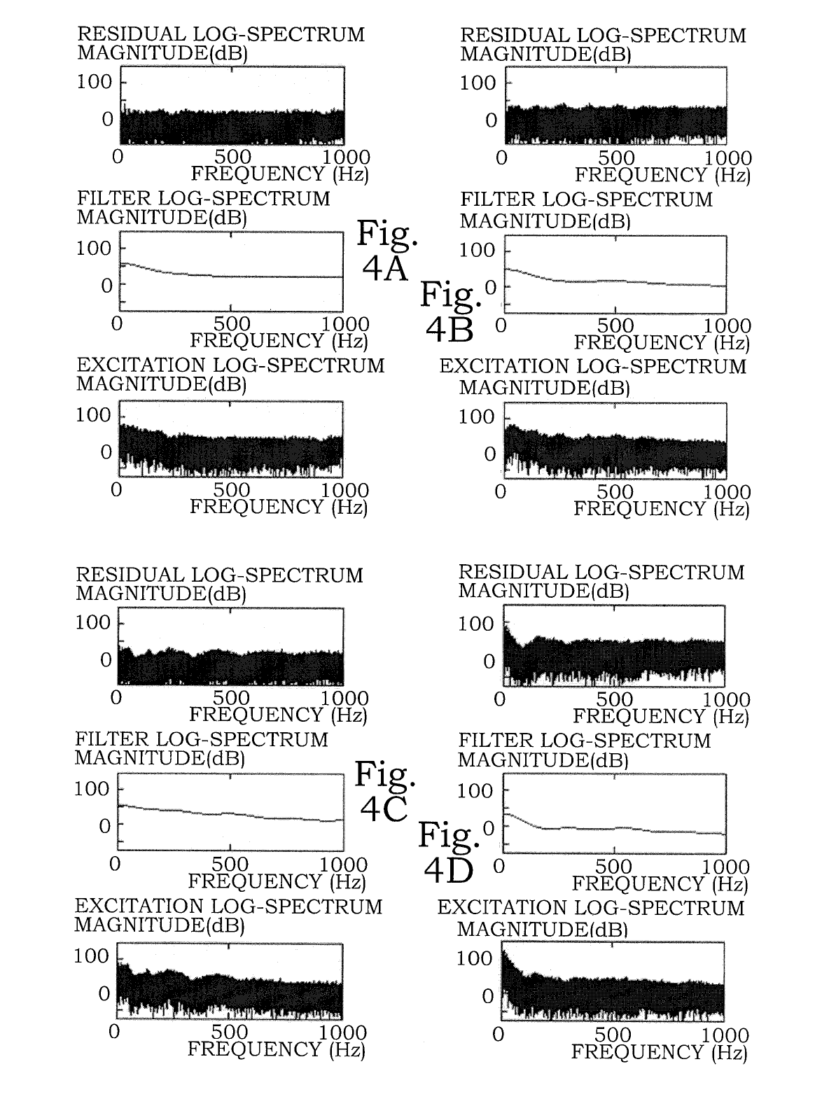

Normal, mild, moderate and severely impaired speech samples have been used as test samples in FIGS. 4A-D, where the two lower diagrams show the vocal tract filter log-power spectrum and the source excitation log-power spectrum, respectively. The speech samples are from Running Speech tests for four PD subjects rated 0, 1, 2 and 3, respectively, during a speech examination by the clinician.

As previously discussed, a muscular constriction may result in the increased magnitude of excitation energy in an impaired speech due to the air turbulence at Trachea Bronchi. This phenomenon may be noticed in the severely impaired speech samples, see FIG. 4D, where the magnitude of excitation log-magnitude spectrum shows higher values comparatively to the normal speech samples, see FIG. 4A. The excitation magnitude in moderately and severely impaired speech samples, see FIGS. 4C and 4D, respectively, exhibited a random pattern of peaks due to short energy bursts. Log-magnitude spectra of mild impaired speech samples are shown in FIG. 4B.

The magnitude of filter log-magnitude spectrum in severely impaired speech samples, FIG. 4D, showed lower values compared to the normal speech samples, FIG. 4A. This is because the glottal openings during normal speech allowed the air pressure to expel unhindered through the vocal folds, whereas in impaired speech, constrictions in the glottal openings blocked the air pressure resulting in reduced magnitude in filter log-magnitude spectrum and may have resulted in a breathy voice.

In case of impaired speech, due to the increase in log-magnitude of the excitation spectrum and the simultaneous reduction in log-magnitude of the filter spectrum, the mathematical difference between the log-magnitudes should be larger in the speech of PWP compared to the normal speech. The difference may also be the cause of unintelligibility in the voice of PWP due to the presence of noise source. With reference to FIG. 3, a residual signal r[ω] 49 is computed as a difference 47 between the source excitation log-power spectrum 44 and the vocal tract filter log-power spectrum 46, i.e. by complementing between the log-magnitudes of excitation and filter spectrums, as given by:

r[ω]=log|E[ω]|−log|H[ω]| (10)

where log|E[ω]| and log|H[ω]| are taken from (8) and (9). r[ω] is in the present disclosure called the ‘Cepstral Separation Difference’ (CSD) where ω is the log-magnitude coefficient of the residual spectrum r[ω]. This can be made within a suitable frequency range, e.g. in one embodiment in the frequency range 0 Hz-1000 Hz (which is a normal voice frequency range). The CSD may be utilized to estimate the pressure wave disturbance caused by the uncontrolled glottal closures in speech. CSD computes the log-magnitude relation between source and filter log-spectrums to estimate the energy difference caused by the raised aspiration in the source. This CSD constitutes a speech characterizing spectrum, from which much information about the origin of the speech can be extracted. Such a CSD can therefore be applied in various applications, as will be further discussed below, and not only in PD monitoring.

In the application of PD, as exemplified by the upper diagrams of the FIGS. 4A-D, the r[ω] in normal speech sample (FIG. 4A) depicts a smooth pattern along the horizontal zero-axis whereas the r[ω] in severely impaired speech (FIG. 4D) depicts a random pattern with higher magnitude values above the horizontal zero-axis. Experiments on PD running speech samples have shown that the elevated aspiration energy in source log-spectrum in conjunction with energy depression in filter log-spectrum results in higher residual values in log-spectrum r[ω], compared to that of speech samples from healthy controls. Moreover, an increasing irregularity in the modulation of log-spectrum r[ω] relative to the increasing symptom severity was observed.

In order to have an easily analyzable quantity describing the CSD, speech-related measures can be extracted from the CSD. In one embodiment, the mean absolute deviation has been utilized. The mean absolute deviation (represented as δ_{CSD}) among the log-magnitudes of residual spectrum r[ω] (in this particular example for ω=1 . . . 1000 Hz) has been computed to measure the dispersion and amplitude variation in the CSD according to:

$${δ}_{CSD} = \frac{1}{1000} 1 {\sum }_{v = 1}^{1000} \vert r [ v ] - \overline{r} \vert \qquad ( 11 )$$

where r̅ is the overall mean of r[ω]. Experiments showed that δ_{CSD} remarkably increases with the increasing anomaly in speech.

Other useful speech-related measures that can be used in other embodiments, assisting with the characterization of the human speech, can be e.g. the interquartile range of the CSD, the central sample moment of the CSD, the mean of the CSD, the root mean square deviation of the CSD and the mean square deviation of the CSD.

For further embodiments of assessments of CSD, other speech-related measures can be extracted from the CSD. Hoarseness in speech is another symptom related to impaired function of the larynx. Hoarseness is produced by an interference with optimum vocal fold adduction characterized by a breathy escape of air on phonation. The vocal fold adduction increases the subglottal pressure at the glottis, resulting in increased aspiration level, followed by a meager propagation of pressure waves in the vocal tract. This phenomenon results in speech depression which can be measured by the CSD by comparing the energy levels between source and filter log-spectrums.

TABLE 1
CSD-based example features for the assessment of speech.

| Measure | Description |
|---|---|
| IQR_CSD | Interquartile range of CSD |
| IQR_P | Interquartile range of CSD peaks |
| IQR_V | Interquartile range of CSD valleys |
| M_CSD | Central sample moment of CSD |
| M_P | Central sample moment of CSD peaks |
| M_V | Central sample moment of CSD valleys |
| MCS | Mean CSD Spread computed as Mean of the amplitudes |
| | between the signal peaks and the adjacent valleys |
| DCS | Deviation in CSD spread computed as Standard |
| | Deviation between the amplitudes between the signal |
| | peaks and the adjacent valleys |
| TCS | Total CSD spread computed as Sum of the amplitudes |
| | between the signal peaks and the adjacent valleys |
| MC | Mean of CSD |
| MPM | Mean of the CSD peaks magnitude |
| DPM | Standard Deviation between the CSD peaks magnitude |
| MVM | Mean of the CSD valleys magnitude |
| DVM | Standard Deviation between the CSD valleys magnitude |
| MPI | Mean of CSD peaks intervals |
| DPI | Standard Deviation between the CSD peaks intervals |
| MVI | Mean of CSD valleys intervals |
| DVI | Standard Deviation between the CSD valleys intervals |
| RMS_CSD | Root Mean Square Deviation of CSD |
| RMS_PM | Root Mean Square Deviation of CSD peaks magnitude |
| RMS_VM | Root Mean Square Deviation of CSD valleys magnitude |
| MS_CSD | Mean Square Deviation of CSD |
| MS_PM | Mean Square Deviation of CSD peaks magnitude |
| MS_VM | Mean Square Deviation of CSD valleys magnitude |

In one embodiment, in order to investigate the depression in speech frequency through CSD, a peak-detector was applied on r[ω] to locate the peaks and the valleys in the CSD that represent the level of residual energy at each frequency. The average peaks' magnitude (AP_{CSD}) was found to be elevated in PD speech samples and was rising with increasing symptom severity. In a particular embodiment, the δ_{CSD} along with AP_{CSD} can be selected as the representative measures of phonatory symptoms for classification of speech symptom severity. The measures listed in table 1 may be utilized to represent features such as the levels and dispersions in the CSD spectrum.

The evaluation of such speech-related measures can use expertise-based methods such as rules (e.g. simple divisions into different ranges or thresholds), unsupervised methods such as principal component analysis or supervised methods such as linear or nonlinear regression methods. The evaluation may also use any combination of such methods using e.g. neuro-fuzzy models.

In one embodiment, a support vector machine (SVM) is used. The SVM is widely relied on in biomedical decision support systems for its ability to regularize global optimality in the training algorithm and for having excellent data-dependent generalization bounds to model non-linear relationships. However, the classification success of SVM depends on the properties of the given dataset and accordingly the choice of an appropriate kernel function. Training a linear SVM is equivalent to finding a hyper plane with maximum separation. In case of a high-dimensional feature space with low input data size, instances may scatter in groups and classification with a linear SVM may lead to imperfect separation between the hyper planes. The solution is then to utilize a nonlinear SVM that maps these features into a ‘higher-dimensional’ space by incorporating slack variables. This leads to a very large quadratic programming (QP) optimization problem but it can be solved using the sequential minimal optimization (SMO) algorithm. SMO decomposes the overall QP problem into QP sub-problems. This decomposition is performed by solving the smallest possible QP optimization problem at every step involving two Lagrange multipliers satisfying the linear equality constraint to find local optima. At each decomposition step, SMO finds the optimal values for these multipliers and updates the SVM cost function to reflect new optimal marginal separations between the hyper planes.

The CSD features may further be utilized also with other recognized speech features such as H1H2 and Mel-frequency cepstral coefficients for an improved speech quality assessment. Such combination can use expertise-based methods such as rules, unsupervised methods such as principal component analysis or supervised methods such as linear or nonlinear regression methods, or any combination of such methods using e.g. neuro-fuzzy models.

In alternative embodiments, as mentioned above, other transform techniques than DFT/IDFT between a time-like domain (spectral or cepstral) and a frequency-like domain (frequency or quefrency) and back can be used. Possible examples are e.g. discrete cosine transforms or Z-transform.

As indicated above, the characterization of the human speech can be further utilized in a step of providing assessment of speech impairment of patients with diagnosed Parkinson's disease. A dataset consisting of 855 speech recordings of 80 subjects out of which 60 were diagnosed with Parkinson's disease was analyzed in a test. Data was acquired from 60 PWPs and 20 normal controls using a computer-based test battery called QMAT. The audio recordings consisted of Sustained Vowel Phonation (SVP) test, Running Speech (RS) test and Laryngeal Dysdiadokokinesis (LDDK) test. In SVP tests, the vocal breathiness of patients in keeping the pitch (e.g. ‘aaaah . . . ’) constant in a given time frame is examined. In L-DDK tests, the ability of patients to produce rapid alternating speech (e.g. ‘puh-tuhkuh . . . puh-tuh-kuh . . . ’) is assessed. In RS tests, subjects were asked to recite static paragraphs displayed on the QMAT screen. The standard RS tests were devised in a way such that the Laryngeal stress in producing consonants i.e. fricatives, plosives and approximants can be assessed. The fricatives are particularly useful for dysarthria assessment as they provide location of linguistic stress in the speech signal. Each subject (considered as an instance) was rated from 0 to 3 by the clinicians based on their performance in the phonation tests.

A total of 855 voice recordings were processed using MATLAB and Speech Filing System (SFS). A Spearman rank-order correlation analysis showed that the δ_{CSD} computed from RS tests is very highly correlated (p=0.77) with MES ratings. The results suggest that the features from the running speech are enough to identify PD speech symptoms if they are able to track deficits in individual speech components.

By use of CSD, improvement in classification accuracy of speech symptoms is proportional to the increasing level of textual difficulty in the data set from mild PD stage. It was observed that the mild speech symptoms were undetected in the recitation of easy-to-read text. Even in this situation, high values of Guttmann's μ₂ (0.70-0.78) suggest that the CSD was robust in characterizing between the speech symptom severity levels. In particular, the δ_{CSD} indicated very strong correlation with the clinical speech ratings and this correlation increased with increasing level of textual difficulty.

Besides, since the CSD features do not incorporate computation of any fundamental frequencies, the strong Guttman correlation between these features and clinical ratings suggests that these features have the potential to detect PD speech anomalies in languages other than English. In general, the high classification performance by the SVM supports this model and the selected pool of features as a suitable tool to categorize speech symptom severity levels in early stage PD.

A device for characterization of a human speech typically comprises a central processing unit. The central processing unit is configured for performing the method steps described earlier.

When applied to Parkinson's disease patients, it is an advantage if at least the recording of the human speech, but preferably also the speech impairment analysis, is performed by a mobile unit to allow the recording to be performed in a relaxed environment. The modern mobile devices with central processing units provide a suitable platform to record speech for an impairment analysis. In FIG. 5, such a system is schematically illustrated. A patient 60 speaks and a mobile device 62 records the human speech. The mobile device 62 constitutes the device 61 for characterization of a human speech. The mobile device 62 in turn comprises a central processing unit 64 performing the actual speech impairment analysis. Mobile operating systems (e.g. Windows Mobile OS) are equipped with memory to store voice clips as well as provide command line interface for computations. In a particular embodiment of a speech analysis apparatus, voice can be recorded in “.wav” format in the voice memory which is an acceptable format for acoustic measurements in MATLAB. The CSD can be computed using MATLAB and MATLAB mobile software may be utilized in the mobile OS to record and analyze speech based on CSD. MATLAB mobile can be connected 66 to a speech database in a central server 68 which may be accessed by the clinicians to track the disease progression.

The implementation of a speech analysis apparatus can of course be performed in many other ways as well. The following modules are typically included. A sound collection module, a storage module, and a CSD features processor are the central components. However, if speech samples are provided from outside, only the CSD features processor is necessary. Furthermore, an established features processor and an overall speech scoring module are also typically included, at least in PD applications. These modules may be placed in one single device or distributed on several devices in a network.

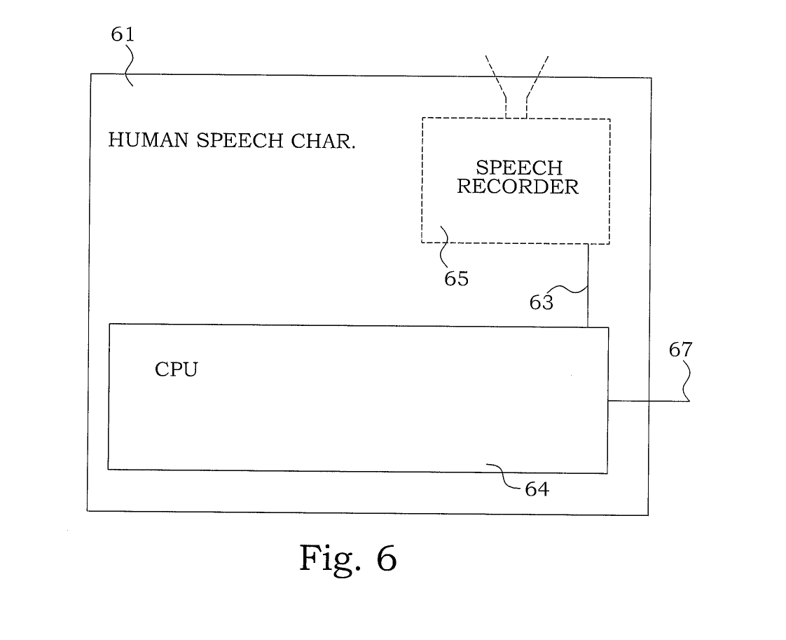

FIG. 6 illustrates a block diagram of an embodiment of a device for characterization of a human speech 61. The device for characterization of a human speech 61 comprises a central processor unit 64. The central processor unit 64 has an input 63 for a speech sample of the human speech in the time domain. In preferred embodiments, the input 63 is connected to a speech recorder 65. The speech recorder 65 is configured for recording running speech as the speech sample of the human speech in the time domain. The processor unit 64 is configured for performing a discrete transform on the speech sample of the human speech in the time domain into the frequency domain, creating a speech frequency spectrum defined by a set of frequency coefficients. The processor unit 64 is further configured for creating a speech logarithmic power spectrum in the log-power domain by taking a logarithmic of the speech frequency spectrum. The processor unit 64 is further configured for performing an inverse discrete transform, being the inverse to the discrete transform, on the speech logarithmic power spectrum into the quefrency domain, creating a speech cepstrum defined by a set of cepstral coefficients. The processor unit 64 is further configured for high-time-liftering of the speech cepstrum, giving a high end speech cepstrum, and for low-time-liftering of the speech cepstrum, giving a low end speech cepstrum. The processor unit 64 is further configured for performing the discrete transform on the high end speech cepstrum into the log-power domain, creating a source excitation log-power spectrum, and for performing the discrete transform on the low end speech cepstrum into the log-power domain, creating a vocal tract filter log-power spectrum. The processor unit 64 is further configured for calculating a cepstral separation difference as a difference between the source excitation log-power spectrum and the vocal tract filter log-power spectrum. The processor unit 64 is further configured for characterizing the human speech based on the cepstral separation difference. The processor unit 64 has an output 67 for the characterization of the human speech.

In the embodiment of FIG. 5, the sound collection module is comprised in the mobile device, as well as a temporary storage module and the CSD features processor. The output result, e.g. in the form of a CSD curve or a quantified CSD feature is transferred at suitable occasions to the central server, where the established features processor and the overall speech scoring module typically are residing. In an alternative way, the sound can be transferred directly to the central server as coded sound and the analysis will then be performed in the central server.

In alternative embodiments, the different system parts may be provided in other configurations as well. In one embodiment, a general purpose computer can be used, connected with a microphone. The general purpose computer comprises software that when executed can perform coding of sound collected by the microphone. The general purpose computer also comprises software that when executed can perform CSD analysis according to the previous described principles.

Researchers and statisticians may utilize the speech database for assessment of trends in speech quality. Physicians and speech therapists may utilize the speech assessments for improving the subjects' voice in speech therapies. A feedback based on the current status of the patients' speech may be generated with a clinical prescription as well as speech therapies can be performed remotely. This will reduce the hospital's overheads to accommodate incoming patients. The effort for the patients to perform speech testing will be minimal since regular telephone conversations can be used as inputs. Data collection could be initiated either by the patient or remotely by the treating clinician. Scores can be distributed via a network to everyone concerned.

The use of the cepstral separation difference for assessments of breathing abnormalities for Parkinson's disease persons is obvious from the above description. However, the CSD is also applicable in other applications as well, where the relation between different parts of the voice production system is concerned. CSD involves individual voice information and could therefore also be used in e.g. voice recognition applications, preferably as a complement to existing voice recognition methods. It is believed that attempts to deliberately distort ones voice may be detected by analyzing the CSD. CSD could also be applied in general speech training. Singers, actors and frequent speakers often consult speech or song consultants in order to improve the quality of their singing or speaking. CSD could be used as a tool for identify the origin of different undesired voice components. Mental stress may influence the voice and will probably mainly influence the excitation spectrum. If CSD results from different situations are compared, such differences in the excitation spectrum can be visible in the CSD. Possible applications by such a feature is e.g. as a lie detector.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

### REFERENCES

[1] K. M. Rosen, R. D. Kent and A. L. Delaney, “Parametric quantitative acoustic analysis of conversation produced by speakers with dysarthria and healthy speakers”, J Speech Lang Hear Res, Vol. 49, 2006, pp. 395-411.
[2] J. Camburn, S. Countryman and J. Schwantz, Parkinson's disease: Speaking Out, The National Parkinson Foundation, Denver, Colo., 1998.
[3] G. Fant, “Glottal source and excitation analysis”, Speech Trans. Lab., Quart. Prog. and Stat. Rep, Vol. 20, No. 1, 1979, pp. 70-85.
[4] Ramig L O, Fox C M, McFarland D, Farley B G. Total Communications and Body Therapy. U.S. Pat. No. 7,762,264, 2010.
[5] N. Solomon, “Speech Breathing in Parkinson's Disease”, J Speech Lang Hear Res, Vol. 36, 1993, pp. 294-310.
[6] Khan. T, Westin. J, “Methods for Detection of Speech Impairment Using Mobile Devices”, RPSP, Vol. 1, No. 2, 2011, pp. 163-171.
[7] A. Tsanas, M. A. Little, E. P. McSharry, J. Spielman, L. O. Ramig, “Novel Speech Signal Processing Algorithms for High-Accuracy Classification of Parkinson's Disease”, IEEE Trans. Bio-Med Eng., Vol. 59, No. 5, 2012, pp. 1264-1271.
[8] R. D. Kent, G. Weismer, J. F. Kent, H. K. Vorperian and J. R. Duffy, “Acoustic studies of Dysarthric speech: methods, progress, and potential”, J Commun Disord., Vol. 32, No. 3, June 1999, pp. 141-80.
[9] L. Thomson, E. Lin and M. P. Robb, “The Impact of Breathiness on the intelligibility of Speech”, Proc. 8th APCSLH, Christchurch, New Zealand, Jan. 11-14, 2011.
[10] J. Walker and P. Murphy, A review of Glottal waveform Analysis, Springer-Verlag, Berlin, 2007, pp. 1-21.
[11] J. L. Flanagan, K. Ishizaka and K. L. Shipley, “Synthesis of speech from a dynamic model of the vocal cords and vocal tract”, BELL SYST TECH J, Vol. 54, No. 3, 1975, pp. 485-506.
[12] Xu, Min, et al. “HMM-based audio keyword generation.” Advances in Multimedia Information Processing-PCM 2004. Springer Berlin Heidelberg, 2005.566-574.
[13] Sahidullah, Md, and Goutam Saha. “Design, analysis and experimental evaluation of block based transformation in MFCC computation for speaker recognition.” Speech Communication 54.4 (2012): 543-565.
[14] A. V. Oppenheim, R. W. Schafer and T. G. Stockham, “Nonlinear filtering of multiplied and convolved signals”, Proc. IEEE, Vol. 56, No. 8, 1968, pp. 1264-1291.

1-13. (canceled)

14. A method for characterization of a human speech, the method comprising:
performing a discrete transform on a speech sample of the human speech in the time domain into the frequency domain, creating a speech frequency spectrum defined by a set of frequency coefficients;
creating a speech logarithmic power spectrum in the log-power domain by taking a logarithmic of the speech frequency spectrum;
performing an inverse discrete transform, being the inverse to the discrete transform, on the speech logarithmic power spectrum into the quefrency domain, creating a speech cepstrum defined by a set of cepstral coefficients;
high-time-liftering of the speech cepstrum, giving a high end speech cepstrum;
low-time-liftering of the speech cepstrum, giving a low end speech cepstrum;
performing the discrete transform on the high end speech cepstrum into the log-power domain, creating a source excitation log-power spectrum;
performing the discrete transform on the low end speech cepstrum into the log-power domain, creating a vocal tract filter log-power spectrum;
calculating a cepstral separation difference as a difference between the source excitation log-power spectrum and the vocal tract filter log-power spectrum; and
characterizing the human speech based on the cepstral separation difference.

15. The method according to claim 14, further comprising:
recording running speech as the speech sample of the human speech in the time domain.

16. The method according to claim 14, further comprising:
computing at least one speech-related measure from the cepstral separation difference, wherein characterizing the human speech is based on the at least one speech-related measure.

17. The method according to claim 16, wherein the at least one speech-related measure is selected from:
mean absolute deviation of cepstral separation difference;
interquartile range of cepstral separation difference;
interquartile range of peaks of cepstral separation difference;
interquartile range of valleys of cepstral separation difference;
central sample moment of cepstral separation difference;
central sample moment of peaks of cepstral separation difference;
central sample moment of valleys of cepstral separation difference;
mean cepstral separation difference spread;
deviation in cepstral separation difference spread;
total cepstral separation difference spread;
mean of cepstral separation difference;
mean of the cepstral separation difference peaks magnitude;
standard deviation between the cepstral separation difference peaks magnitude;
mean of the cepstral separation difference valleys magnitude;
standard deviation between the cepstral separation difference valleys magnitude;
mean of the cepstral separation difference peaks intervals;
standard deviation between the cepstral separation difference peaks interval;
mean of the cepstral separation difference valleys intervals;
standard deviation between the cepstral separation difference valleys intervals;
root mean square deviation of cepstral separation difference;
root mean square deviation of cepstral separation difference peaks magnitude;
root mean square deviation of cepstral separation difference valleys magnitude;
mean square deviation of cepstral separation difference;
mean square deviation of cepstral separation difference peaks magnitude; and
mean square deviation of cepstral separation difference valleys magnitude.

18. The method according to claim 16, wherein the at least one speech-related measure is mean absolute deviation of cepstral separation difference.

19. The method according to claim 16, wherein the at least one speech-related measure is average peaks' magnitude of cepstral separation difference

20. The method according to claim 14, wherein the discrete transform is selected as one of:
a discrete Fourier transform;
a discrete cosine transform; and
a discrete Z-transform.

21. The method according to claim 14, further comprising:
providing assessment of speech impairment of patients with diagnosed Parkinson's disease, based on the characterization of the human speech.

22. The method according to claim 14, further comprising:
performing a speech recognition, based on the characterization of the human speech.

23. The method according to claim 14, further comprising:
performing a lie detection, based on the characterization of the human speech.

24. The method according to claim 14, further comprising:
performing speech training, assisted by the characterization of the human speech.

25. The method according to claim 15, further comprising:
computing at least one speech-related measure from the cepstral separation difference, wherein characterizing the human speech is based on the at least one speech-related measure.

26. The method according to claim 25, wherein the at least one speech-related measure is selected from:
mean absolute deviation of cepstral separation difference;
interquartile range of cepstral separation difference;
interquartile range of peaks of cepstral separation difference;
interquartile range of valleys of cepstral separation difference;
central sample moment of cepstral separation difference;
central sample moment of peaks of cepstral separation difference;
central sample moment of valleys of cepstral separation difference;
mean cepstral separation difference spread;
deviation in cepstral separation difference spread;
total cepstral separation difference spread;
mean of cepstral separation difference;
mean of the cepstral separation difference peaks magnitude;
standard deviation between the cepstral separation difference peaks magnitude;
mean of the cepstral separation difference valleys magnitude;
standard deviation between the cepstral separation difference valleys magnitude;
mean of the cepstral separation difference peaks intervals;
standard deviation between the cepstral separation difference peaks interval;
mean of the cepstral separation difference valleys intervals;
standard deviation between the cepstral separation difference valleys intervals;
root mean square deviation of cepstral separation difference;
root mean square deviation of cepstral separation difference peaks magnitude;
root mean square deviation of cepstral separation difference valleys magnitude;
mean square deviation of cepstral separation difference;
mean square deviation of cepstral separation difference peaks magnitude; and
mean square deviation of cepstral separation difference valleys magnitude.

27. The method according to claim 15, wherein the discrete transform is selected as one of:
a discrete Fourier transform;
a discrete cosine transform; and
a discrete Z-transform.

28. The method according to claim 15, further comprising:
providing assessment of speech impairment of patients with diagnosed Parkinson's disease, based on the characterization of the human speech.

29. The method according to claim 15, further comprising:
performing a speech recognition, based on the characterization of the human speech.

30. The method according to claim 15, further comprising:
performing a lie detection, based on the characterization of the human speech.

31. The method according to claim 15, further comprising:
performing speech training, assisted by the characterization of the human speech.

32. A device for characterization of a human speech, comprising:
a central processor unit having an input for a speech sample of the human speech in the time domain;
the central processor unit being configured for
performing a discrete transform on the speech sample of the human speech in the time domain into the frequency domain, creating a speech frequency spectrum defined by a set of frequency coefficients;
creating a speech logarithmic power spectrum in the log-power domain by taking a logarithmic of the speech frequency spectrum;
performing an inverse discrete transform, being the inverse to the discrete transform, on the speech logarithmic power spectrum into the quefrency domain, creating a speech cepstrum defined by a set of cepstral coefficients;
high-time-liftering of the speech cepstrum, giving a high end speech cepstrum;
low-time-liftering of the speech cepstrum, giving a low end speech cepstrum;
performing the discrete transform on the high end speech cepstrum into the log-power domain, creating a source excitation log-power spectrum;
performing the discrete transform on the low end speech cepstrum into the log-power domain, creating a vocal tract filter log-power spectrum;
calculating a cepstral separation difference as a difference between the source excitation log-power spectrum and the vocal tract filter log-power spectrum; and
characterizing the human speech based on the cepstral separation difference;
the central processor unit having an output for the characterization of the human speech.

33. The device according to claim 32, further comprising:
a speech recorder, connected to the input, the speech recorder being configured for recording running speech as the speech sample of the human speech in the time domain.
